(19) United States
(12) Patent Application Publication
(10) Pub. No.: US 2002/0133451 A1
(43) Pub. Date: Sep. 19, 2002

(54) Dynamic price changing web marketing system and the method for the same

(76) Inventors: Chih-Hua Wang, Taipei (TW); Shih-Ping Lin, Kaohsiung (TW)

Correspondence Address: BIRCH STEWART KOLASCH & BIRCH, PO BOX 747, FALLS CHURCH, VA, 22040-0747, US

(21) Appl. No.: 09/808,118

(22) Filed: Mar. 15, 2001

(51) Int. Cl. G06F 17/60

(52) U.S. Cl. 705/37; 705/26

(57) ABSTRACT

A dynamic price changing web marketing system, which comprises a commodity database, a commodity data providing module, and a trade processing module. The commodity database stores at least one commodity datum. The commodity providing module provides commodity data in a specific format. The trade processing module receives consumer's order for purchasing commodities. It is further characterized in that it contains a dynamic price changing module that gradually lowers the commodity price from an initial price. The commodity data providing module immediately provides the lowered price to the consumer. The trade processing module receives the consumer's order for purchasing the commodity when the price is lowered to a specific value. The invention also discloses a corresponding dynamic price changing web marketing method.

### BACKGROUND OF THE INVENTION

1. Field of Invention

The invention relates to a dynamic price changing web marketing system and the corresponding method. More particularly, the invention relates to a dynamic price changing web marketing system that lowers the commodity price over a certain period of time and receives the consumer's order for purchasing the commodity.

2. Related Art

As computer-related technologies have been rapidly developing, utilizing the network to conduct electronic commerce (E-commerce) has become the new business trend. In general, E-commerce refers to a modem business model whose purpose is to more rapidly react according to the request of merchants or consumers so as to lower costs and increase the quality of service. Taking the B2C E-commerce model as an example, with the fast speed and high interactivity of the computer and networks, merchants can perform various businesses such as online advertising, online ordering, and online consumer services for different consumers. The consumer can browse the commodities and the services provided by various merchants and compare prices or trade. Without a doubt, in such a competitive E-commerce environment, how to attract consumers to connect to the web store of a merchant is one of the most important issues. In the prior art, methods to attract consumers to the merchant include lottery activities. However, this method is no different from the conventional commercial sale activities. I other words, this method does not fully use the characteristics of computer and network technologies (for example, higher interactivity between the merchant and consumers) to make consumers more willing to connect to the web store, achieving the goals of lowering costs and increasing service qualities.

### SUMMARY OF THE INVENTION

Pursuant the above problem, it is an objective of the invention to provide a dynamic price changing web marketing system and its corresponding method to increase the purchase motivation of the consumer and the number of consumers connecting to the merchant's web store.

It is another objective of the invention to provide a dynamic price changing web marketing system and its corresponding method that can dynamically provide a lower commodity price to the consumer so as to stimulate the consumer to purchase through the network.

To achieve the above objectives, the disclosed dynamic price changing web marketing system includes a commodity database, a commodity data providing module and a trade processing module. The commodity database stores at least one commodity datum. The commodity providing module provides commodity data in a specific format. The trade processing module receives consumer's order for purchasing commodities. It is further characterized in that it contains a dynamic price changing module that gradually lowers the commodity price from an initial price. The commodity data providing module immediately provides the lowered price to the consumer. The trade processing module receives the order for purchasing the commodity from the consumer when the price is lowered to a specific value.

The invention also provides a dynamic price changing web marketing method, which reads in a commodity datum from a commodity database, provides the commodity datum in a specific format to a consumer using a commodity data providing module, and receives the consumer's order for purchasing the commodity using a trade processing module. The method is characterized in that: when the commodity data providing module provides commodity data to the consumer, a dynamic price changing module gradually lowers the commodity price from an initial price from an initialization time. The commodity data providing module further provides the lowered price to the consumer. The trade processing module further receives the consumer's order for purchasing the commodity when the price is lowered to a specific value.

The disclosed dynamic price changing web market system and method fully utilize the fast speed and high interactivity of computer and network technologies and perform dynamic price changing web marketing activities for consumers at different locations. Therefore, the invention can achieve effects that are not conventionally possible.

### BRIEF DESCRIPTION OF THE DRAWINGS

The invention will become more fully understood from the detailed description given in the herein below illustration only, and thus do not limit the invention, and wherein:

FIG. 1 is a schematic view of the dynamic price changing web marketing system according to a preferred embodiment of the invention;

FIG. 2 is a schematic view of the data structure in the commodity database of the dynamic price changing web marketing system in FIG. 1;

FIG. 3 is a schematic view of the data structure in the consumer database of the dynamic price changing web marketing system in FIG. 1; and

FIG. 4 is a flowchart outlining the procedure for implementing the dynamic price changing web marketing method according to a preferred embodiment of the invention.

### DETAILED DESCRIPTION OF THE INVENTION

Preferred embodiments of the dynamic price changing web marketing system and the corresponding method will be apparent from the following detailed description, which proceeds with reference to the accompanying drawings, wherein the same references relate to the same elements.

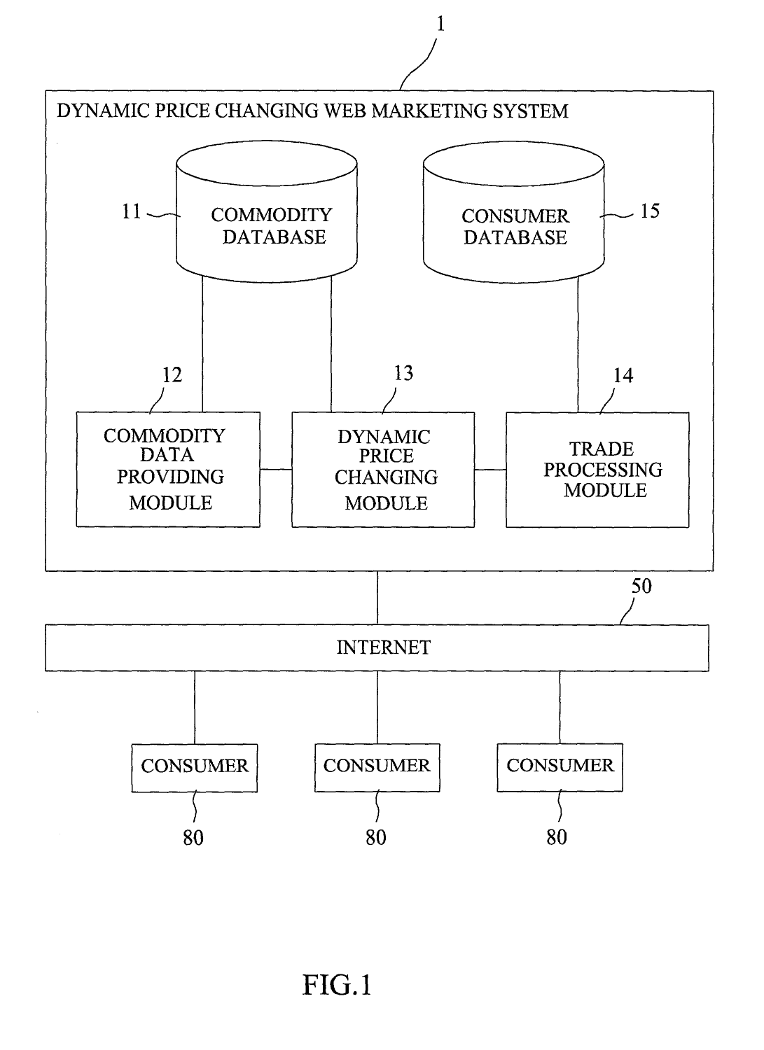

With reference to FIG. 1, a preferred embodiment of the dynamic price changing web marketing system 1 of the invention includes a commodity database 11, a commodity data providing module 12, a dynamic price changing module 13, a trade processing module 14 and a consumer database 15. In this embodiment, the system 1 is implemented on a web server with at least one central processing unit (CPU) and at least one storage device. Each module is a program module stored in the storage device. Each database is also stored in the storage device. After the CPU reads in the program code of each program module from the storage device, subsequent procedures in the dynamic price changing web marketing method can be carried out with other assisting software and hardware in the web server.

The above-mentioned storage device can be any computer readable storage device, such as a hard disk drive (HDD) or random access memory (RAM). The database can use any database structure commonly used by people skilled in the art, such as the SQL database or Access database. Each module can be a program module composed of some program code written in, for example, C language or ASP language.

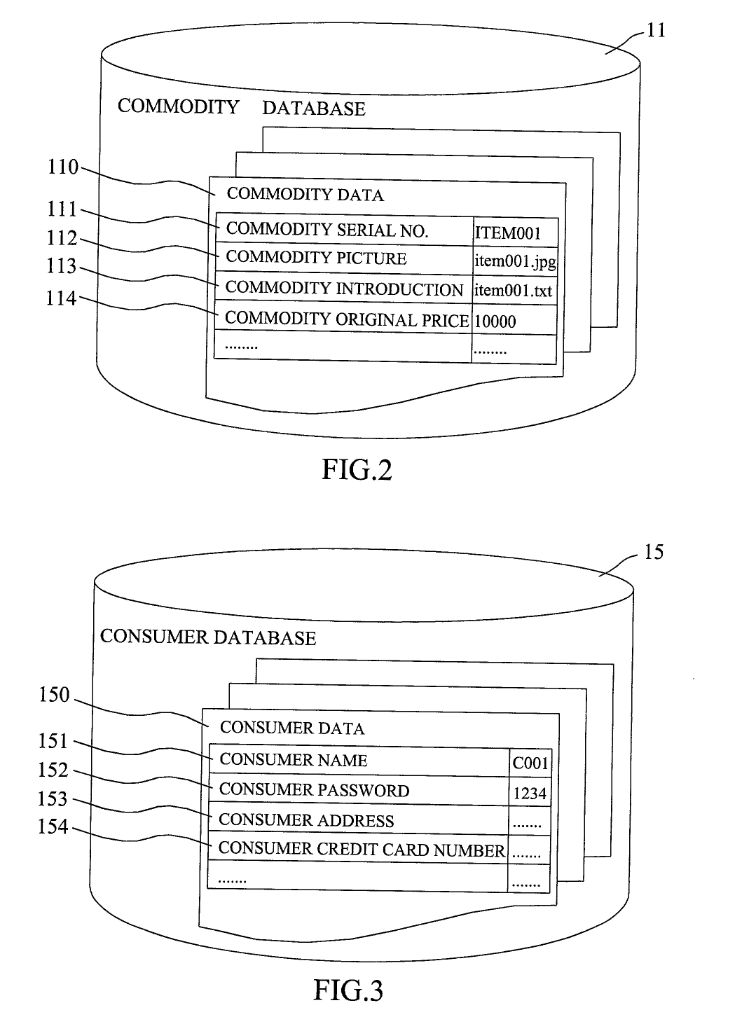

With reference to FIG. 2, the commodity database 11 stores several commodity data 110, each including a commodity serial number 1 1 1, a commodity picture 1 12, a commodity introduction 113, etc. Furthermore, the commodity data 110 also includes the original price 114 of the commodity.

Referring to FIG. 3, the consumer database 15 stores several consumer data 150, each including a consumer name 151, a consumer password 152, a consumer address 153, and a consumer's credit card number 154. Through the consumer data 150, the dynamic price changing web marketing system 1 can perform trades with consumers 80. For example, when a consumer 80 selects a specific commodity, from the consumer database 15 the system 1 can directly retrieve the consumer's credit card number 154 to complete the payment process and the consumer's name and address to send the commodity to the consumer 80.

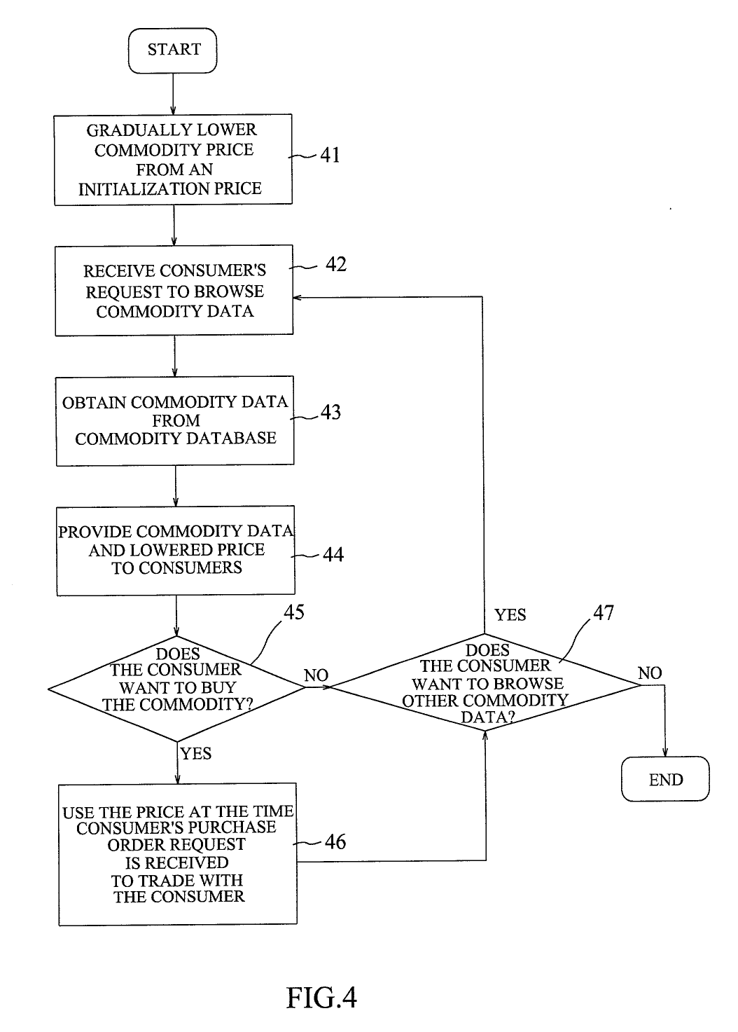

Please refer to FIG. 4 for a better understanding of the following procedure for the dynamic price changing web marketing method according to a preferred embodiment of the invention.

First, in step 41, the dynamic price changing module 13 gradually lowers the commodity price starting from an initial price. The dynamic price changing module 13 can adjusts the initialization time to lower the price, the price lowering rate and the lowest price or the finishing time for lowering the price according to the merchant's settings. The initial commodity price can be the price stored in the commodity database 11. After the initial set up is complete, the merchant can first perform some advertising activities (such as web advertisements or sending solicitous E-mail) so that the potential consumers of the commodity can know of the time for this dynamic price changing activity of the commodity.

Afterwards, in step 42, the system 1 starts to receive the user's order for browsing the commodity with a lowering price. After receiving this request, the commodity data providing module 12 reads in commodity data 110 from the commodity database 11 and provides the commodity data 110 and the lowered price to the consumer 80 in steps 43 and 44.

In this embodiment, the commodity data providing module 12 provides the commodity data 110 and the lowed price in the HTML format to the consumer 80 through the Internet 50. Since the commodity price drops monotonically with time, the consumer 80 will see different commodity prices at different times. This part can be achieved in several ways. For example, the consumer 80 reloads the HTML document to obtain the latest price; an applet element is sent to the consumer's computer so as to continuously update the commodity price; or a relation between the price and time is explicitly explained in the HTML document. When the consumer 80 purchases a commodity, the commodity price is displayed again for the consumer 80 to confirm. Those who are skilled in the art can decide which method to use according to practical situations.

If the consumer 80 decides to purchase the commodity with the lowered price in step 45, the procedure continues to step 46 to obtain the price at the time the consumer 80 makes the purchase request and uses that price to trade with the consumer 80. That is, when the consumer 80 sends out the purchase request, the dynamic price changing module 13 will check what price the commodity is selling at and provide that price to the trade processing module 14. The trade processing module 14 then performs the payment process using this price and other trade actions according to the commodity data 110 and the consumer data 150.

If the consumer selects to browse other commodity data in step 47, the procedure returns to step 42 to wait for the consumer's order to browse commodities.

According to the above-mentioned procedure, the disclosed system and method according to the preferred embodiments can lower the commodity price over time to attract consumers to purchase the commodity. The web merchant can thereby design various sale or advertising activities to attract consumers. For example, the merchant can set a limited quantity of commodities (such as only one commodity at a time) whose price continues to drop within a certain period of time and then returns to the original price thereafter. Since the quantity is limited, only those who purchase early can obtain them. On the other hand, however, over time the commodity price lowers. It thus is a very intriguing marketing style.

In addition, since the system and method according to the disclosed preferred embodiments fully utilizes the fast speed and high interactivity of computer and network technologies to conduct dynamic price changing web marketing activities for consumers located at different places, they can achieve effects that are impossible for conventional marketing methods. They can perform dynamic price changing web marketing activities for consumers at different locations during a selected period of time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dynamic price changing web marketing system, which comprises:
a commodity database for storing at least one commodity datum;
a commodity data providing module for providing the commodity datum in a specific format to a consumer; and
a trade processing module for receiving the user's order for purchasing the commodity,
wherein the system further comprises a dynamic price changing module for lowering the commodity price starting from an initialization time; the commodity data providing module immediately provides the lowered price to the consumer; and the trade processing module receives the user's purchase order when the commodity price lowers to a specific value.

2. The system of claim 1, wherein the dynamic price changing module further provides a price lowering period so that the commodity price goes back to its original price after the price lowering period.

3. The system of claim 1, wherein the dynamic price changing module further provides a limited quantity for the commodity so that the commodity price goes back to its original price when the limited quantity of commodities are sold out.

4. The system of claim 1, wherein the specific format refers to the web page format edited in hypertext markup language (HTML).

5. The system of claim 1, wherein the commodity data providing module provides the commodity data to the consumer through the Internet; and the trade processing module receives the user's purchase order sent by the consumer via the Internet.

6. A dynamic price changing web marketing method, which comprises the steps of:
reading in a commodity datum from a commodity database;
providing the commodity datum in a specific format from a commodity data providing module to a consumer; and
receiving the consumer's order for purchasing the commodity using a trade processing module;
wherein when the commodity data providing module provides the commodity datum to the consumer a dynamic price changing module gradually lowers the commodity price starting from an initial price beginning from an initialization time; the commodity data providing module immediately provides the lowered price to the consumer; and the trade processing module receives the user's purchase order when the commodity price lowers to a specific value.

7. The method of claim 6 further comprising the step of providing a price lowering period by the dynamic price changing module so that the commodity price goes back to its original price after the price lowering period.

8. The method of claim 6 further comprising the step of providing a limited quantity for the commodity by the dynamic price changing module so that the commodity price goes back to its original price when the limited quantity of commodities are sold out.

9. The method of claim 6, wherein the specific format refers to the web page format edited in hypertext markup language (HTML).

10. The method of claim 6, wherein the commodity data providing module provides the commodity data to the consumer through the Internet; and the trade processing module receives the user's purchase order sent by the consumer via the Internet.
